(19) United States
(12) Patent Application Publication
(10) Pub. No.: US 2010/0100803 A1
(43) Pub. Date: Apr. 22, 2010

(54) COMPUTER PRODUCT, SPREADSHEET GENERATING APPARATUS, AND SPREADSHEET GENERATING METHOD

(75) Inventors: Hirotoshi Okushiro, Kawasaki (JP); Masahiro Kurishima, Kawasaki (JP); Kouji Tachibana, Kawasaki (JP); Hideaki Matsui, Kanazawa (JP); Takayoshi Mizuma, Kanazawa (JP); Kenji Ura, Kanazawa (JP); Michiyo Yamashita, Kanazawa (JP); Hideo Sano, Toyama (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); PFU LIMITED, Kahoku-shi (JP)

(21) Appl. No.: 12/643,630

(22) Filed: Dec. 21, 2009

Related U.S. Application Data
(63) Continuation of application No. PCT/JP2007/063017, filed on Jun. 28, 2007.

(51) Int. Cl. G06F 17/00

(52) U.S. Cl. 715/217; 715/243; 715/227

(57) ABSTRACT

A computer-readable recording medium stores therein a spreadsheet generating program that causes a computer to execute acquiring information related to layout positions of items in a form; column-sorting the items in ascending order, according to column-related coordinate values of the items; determining a column width for each of the items, based on a distance to the previous item in the column-sorted items; row-sorting the items in ascending order, according to row-related coordinate values of the items; determining a row height for each of the items, based on a distance to the previous item in the row-sorted items; designating, for each of the items and from among cells having the determined column widths and the determined row heights, a cell corresponding to a layout position indicated in the acquired information; and outputting a spreadsheet related to layout of the form by a provision of the items to the designated cells.

This application is a continuation, filed under 35 U.S.C. §111(a), of PCT International Application No. PCT/JP2007/063017 which has an international filing date of Jun. 28, 2007, and designated the United States of America.

### FIELD

The embodiment discussed herein is related to a computer product, a spreadsheet generating apparatus, and spreadsheet generating method.

### BACKGROUND

Conventionally, secondary utilization, e.g., manipulation and graphing, of data that is in a printed form is troublesome and time consuming. A common method for accomplishing secondary utilization involves reading the printed material using a scanner and converting the data into a PDF or text format using an optical character recognition (OCR) application followed by manual conversion into a spreadsheet application format, a text application format, etc. Techniques for automatically determining the width and height of cells in a spreadsheet as well as automatically generation cell links have been disclosed (see, for example, Japanese Laid-Open Patent Publication No. 2002-7953).

However, secondary utilization of printed data according to such conventional techniques involves operations for conversion such as data “extraction”, “data conversion”, “input to other application”, etc. Further, if there is a large volume of printed data, in addition to an application for printing, an application that extracts the data from a database and manipulates the data has to be developed.

According to the technique disclosed in Japanese Laid-Open Patent Publication No. 2002-7953, since a cell is automatically generated for each rectangle, even if the size of a rectangle is excessively large, the rectangle is used as is for a cell and as a result, the printed material is unable to be accurately reproduced. On the other hand, even if the size of a rectangle is excessively small, the rectangle is used as is for a cell, becoming a useless cell at editing.

### SUMMARY

According to an aspect of an embodiment, a computer-readable recording medium storing therein a spreadsheet generating program that causes a computer to execute acquiring information related to layout positions of items in a form; column-sorting the items in ascending order, according to column-related coordinate values of the items; determining a column width for each of the items, based on a distance from the item to the previous item in the column-sorted items; row-sorting the items in ascending order, according to row-related coordinate values of the items; determining a row height for each of the items, based on a distance from the item to the previous item in the row-sorted items; designating, for each of the items and from among cells having the determined column widths and the determined row heights, a cell corresponding to a layout position indicated in the acquired information related to layout positions; and outputting a spreadsheet related to layout of the form by a provision of the items to the designated cells.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is schematic of an example of a form;

FIGS. 2 and 3 are schematics of spreadsheets of the form depicted in FIG. 1;

FIG. 4 is a diagram of a configuration of a spreadsheet generating apparatus according to an embodiment;

FIG. 5 is a schematic of a form definition field displayed on a display screen at the time of utilization a form defining tool;

FIG. 6 is a schematic of format defining information;

FIG. 7 is a schematic of data configuration of item information;

FIG. 8 is a schematic of an example of item information;

FIG. 9 is a schematic of data configuration of style information;

FIG. 10 is a schematic of cell control information;

FIG. 11 is a schematic of hardware configuration of the spreadsheet generating apparatus;

FIG. 12 is a schematic of cell defining information;

FIG. 13 is schematic of items sorted in ascending order of X-coordinates;

FIG. 14 is a schematic of column width adjustment;

FIG. 15 is a flowchart of spreadsheet generation processing according to the embodiment;

FIG. 16 is a flowchart of processing for generation of cell defining information;

FIG. 17 is a flowchart of column width calculation processing depicted in FIG. 16;

FIG. 18 is a flowchart of column height calculation processing depicted in FIG. 16; and

FIG. 19 is a flowchart of spreadsheet output processing depicted in FIG. 15.

### DESCRIPTION OF EMBODIMENTS

Preferred embodiments of the present invention will be explained with reference to the accompanying drawings.

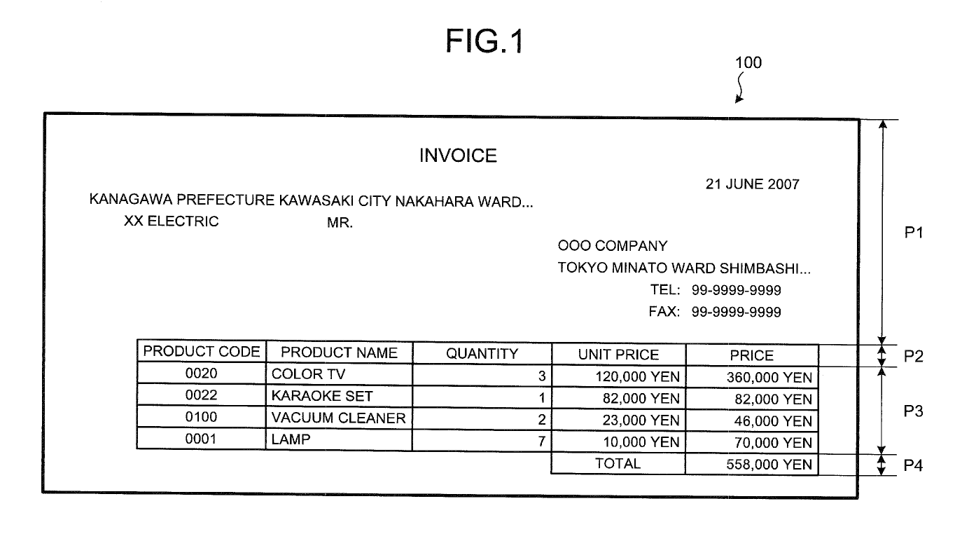

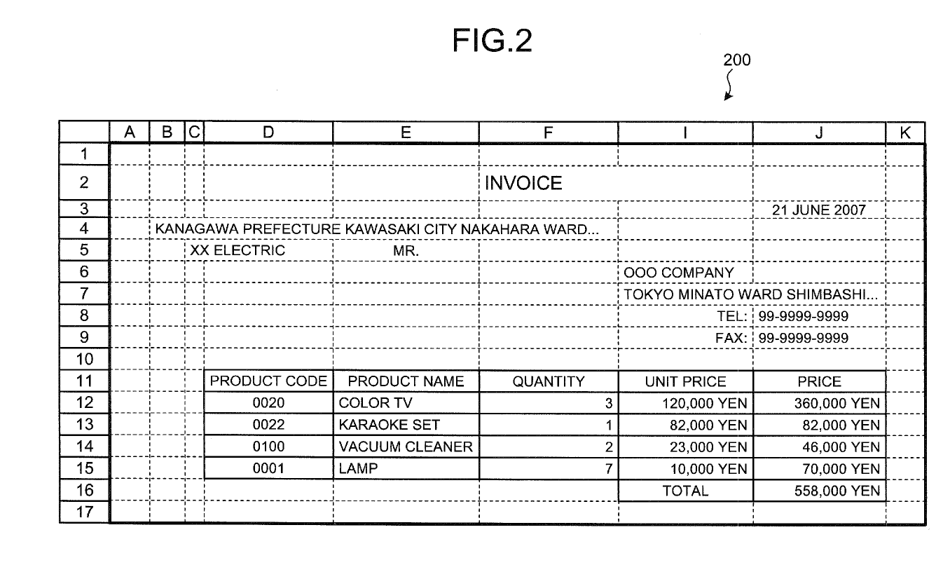

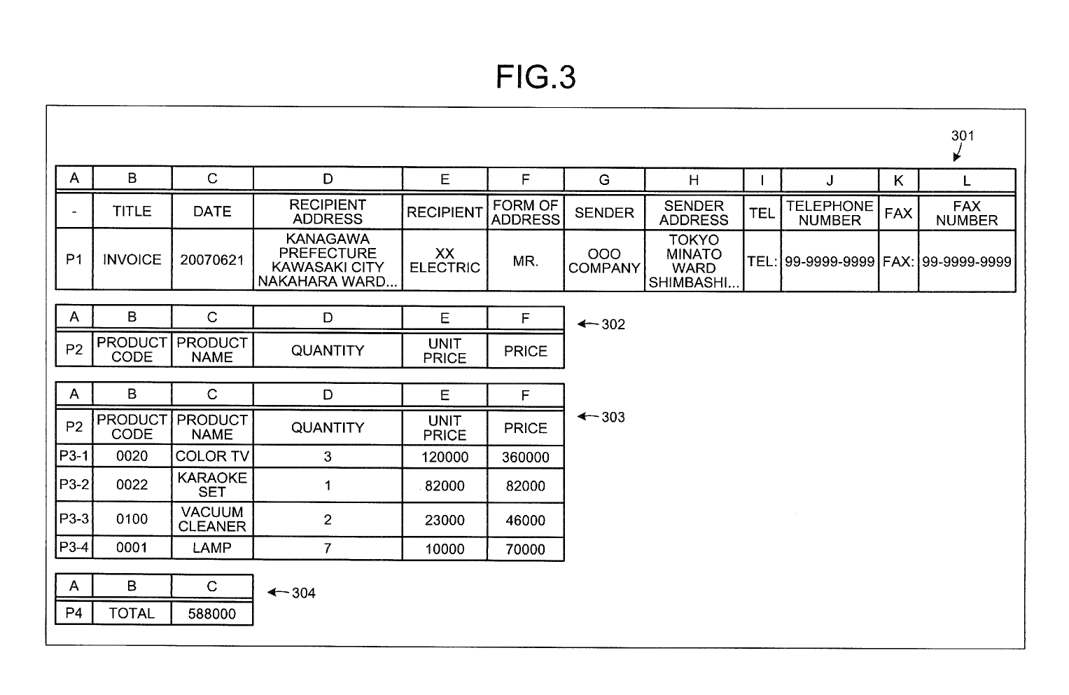

FIG. 1 is schematic of an example of a form. FIGS. 2 and 3 are schematics of spreadsheets of the form depicted in FIG. 1. In the present embodiment, when a spreadsheet of a form 100, such as the paper medium depicted in FIG. 1, is to be printed, character strings for items like “INVOICE”, “21 Jun. 2007”, etc. and the layout position thereof are individually provided to a computer to thereby automatically generate an output file constituted by the spreadsheets depicted in FIGS. 2 and 3. By printing the output file, the form 100 depicted in FIG. 1 is output as printed material.

Spreadsheets 200, 301 to 304 depicted in FIGS. 2 and 3 are, for example, formed by output files of a commercial spreadsheet application. For example, if Microsoft Office Excel distributed by Microsoft Corporation is used, the spreadsheets 200, 301 to 304 are output as a single sheet, i.e., the output file is equivalent to a “book” in Microsoft Office Excel.

In FIGS. 2 and 3, an uppermost row of alphabet characters identify columns; a leftmost column of numerals identify rows. Thus, hereinafter, a cell is identified by a combination of alphabet character(s) representing a column and numeral(s) representing a row, for example, “cell A3”.

In the present specification, the spreadsheet 200 depicted in FIG. 2 is referred to as a “layout sheet” and the spreadsheets 301 to 304 depicted in FIG. 3 are referred to as “data sheets”. The data sheets 301 to 304 are divided into plural sheets according to partitions. A partition is an area into which the form 100 is divided. In FIG. 1, the form 100 is divided into 4 partitions P1 to P4.

In FIG. 3, reference numeral 301 is a data sheet for partition P1, reference numeral 302 is a data sheet for partition P2, reference numeral 303 is a data sheet for partition P3, and reference numeral 304 is a data sheet for partition P4. In this example, the data sheets 301 to 304 are divided according to partitions; however, the data of plural partitions may be described in a single data sheet.

The layout sheet 200 and the data sheets 301 to 304 are linked by common items. For example, cell F2 depicted in FIG. 2 and describing the character string “INVOICE” is linked to cell B2 depicted in FIG. 3 and describing the character string “INVOICE” in the data sheet 301 for partition P1. Thus, when the user wishes to edit the layout sheet 200, by editing the data sheets 301 to 304, the changes are reflected in the layout sheet 200 without actual editing of the layout sheet 200.

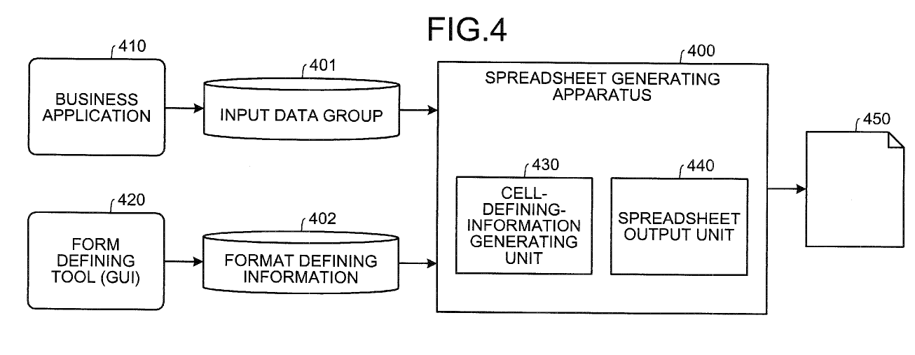

FIG. 4 is a diagram of a configuration of a spreadsheet generating apparatus according to an embodiment.

As depicted in FIG. 4, a spreadsheet generating apparatus 400 obtains an input data group 401 output by a business application 410 and format defining information 402 output by a form defining tool 420 to thereby generate an output file 450. The output file 450 is a file that is output combining the layout sheet 200 and the data sheets 301 to 304 into 1 book.

The input data group 401 is data equivalent to the data, e.g., character strings, numerals, etc., in the data sheets 301 to 304. For example, CSV format data strings may be provided.

For example, in the case of the input data strings related to the partition P1 depicted in FIG. 1, in ascending order of row numbers and column numbers, data strings are separated by commas, e.g., “INVOICE, 27 Jun. 2007, Kanagawa Prefecture Kawasaki City Nakahara Ward . . . , XX Electric, Mr., OOO Company, Tokyo Minato Ward Shimbashi . . . , Tel:, 99-9999-9999, FAX:, 99-9999-9998”. The input data 401 may be a spreadsheet(s) identical to the data sheets 301 to 304.

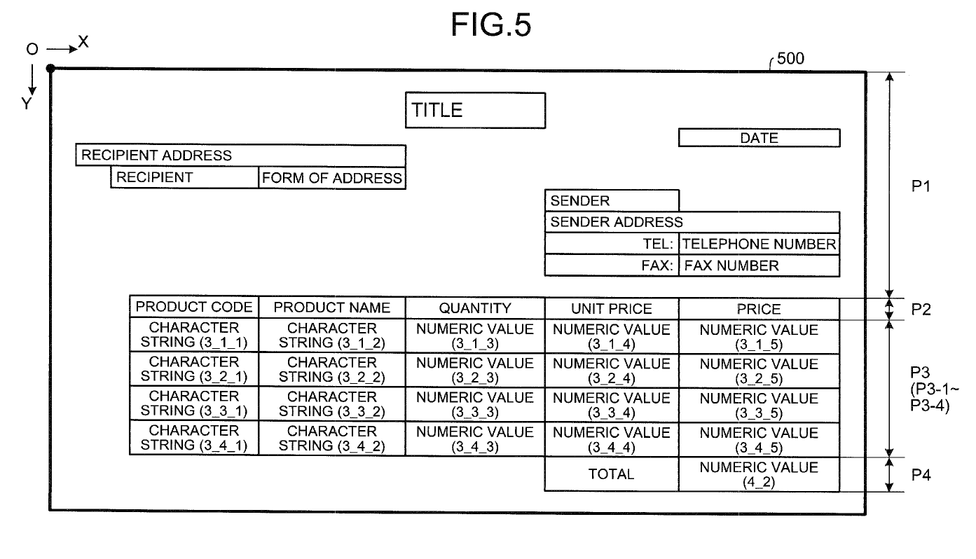

The format defining information 402 is generated through the use of the form defining tool 420 by the user. FIG. 5 is a schematic of a form definition field displayed on a display screen at the time of utilization the form defining tool 420. A form definition field 500 depicted in FIG. 5 includes rectangles that represent items and into which the user inputs item names or that are defined in advance by the form defining tool 420.

The user adjusts the size of and moves the items to thereby determine layout positions of the items. The partitions P1 to P4 are also determined automatically or by the user manually. The input data group 401 is obtained by reference to the form definition field 500 and user input.

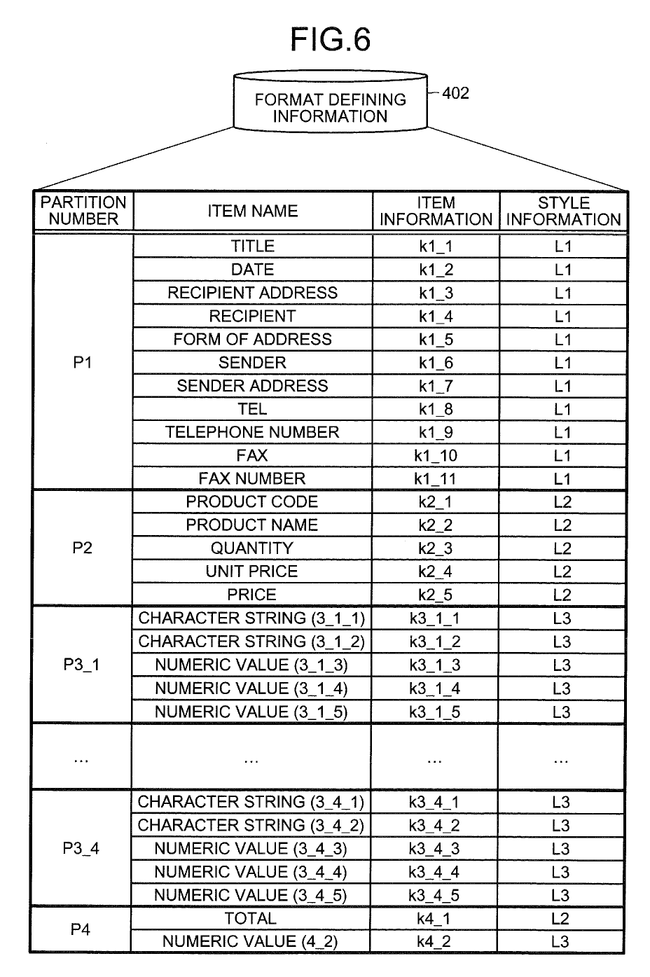

When the form definition field 500 has been determined, the form defining tool 420 generates the format defining information 402 from the form definition field 500. FIG. 6 is a schematic of the format defining information 402. The format defining information 402 depicted in FIG. 6 includes item information and style information for each of the item names in the form definition field depicted in FIG. 5.

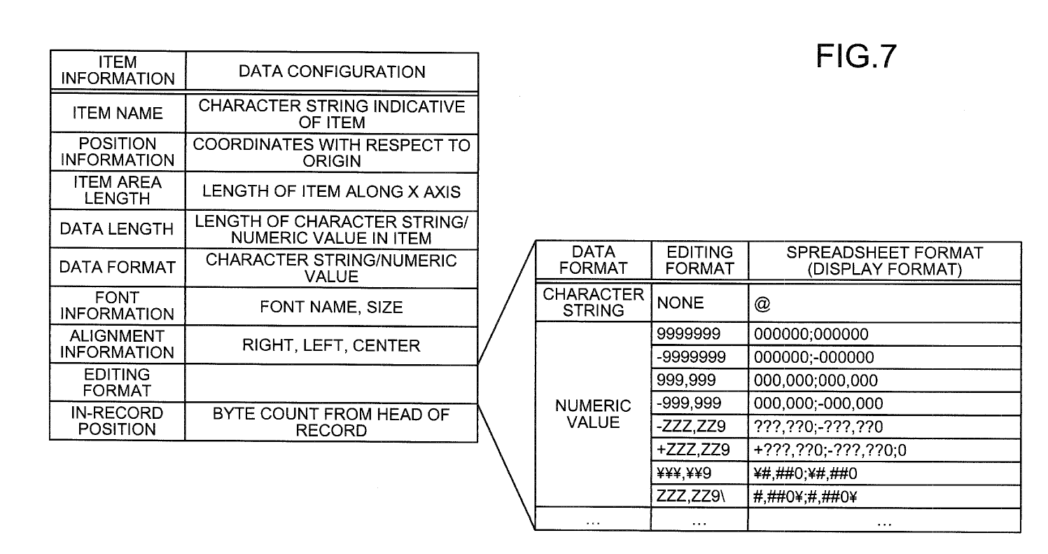

FIG. 7 is a schematic of data configuration of the item information. The item names depicted in FIG. 1 are character strings identifying the items, such as “TITLE”, “DATE”, and RECIPIENT″ depicted in FIG. 5. Position information indicates coordinates in an XY coordinate system having an origin at a left uppermost point of the form definition field 500 depicted in FIG. 5. Item area length is the length of an item along the X axis. Data length is the length (bytes) of a character string/numeric string in an item. An item name in a data string may be detected using the position information and data length. Data format indicates whether an item name is of a character string format or a numeric value format.

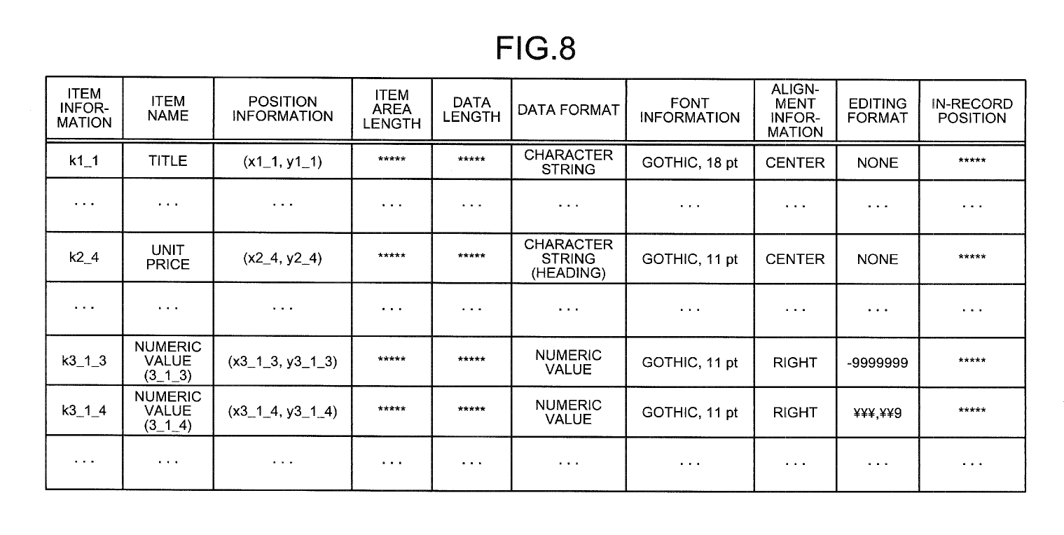

Font information is information indicative of the font name and font size of an item name. Alignment information is information selected from among left, right, and center alignments. Editing format is a spreadsheet format corresponding to the data format of an item name and is the format used for display. An in-record position is a byte count from the head of a record, which is formed by 1 input data string. FIG. 8 is a schematic of an example of item information.

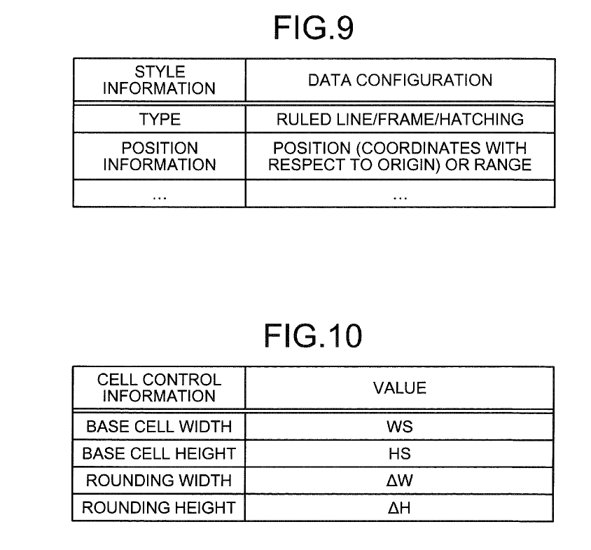

FIG. 9 is a schematic of data configuration of style information. Style information is information for the cells corresponding to the items and is indicative of the type of style (ruled lines, frames, hatching) and the position thereof, or is information indicative of the range.

Cell control information is also provided as the format defining information 402. FIG. 10 is a schematic of cell control information. Cell control information is information defining the basic cell width, the basic cell height, a rounding width, and a rounding height. Here, a rounding width is the upper limit to which a cell is not newly generated and is related to column width. Similarly, a rounding height is the upper limit to which a cell is not newly generated and is related to row height. Rounding widths and rounding heights will be further explained hereinafter.

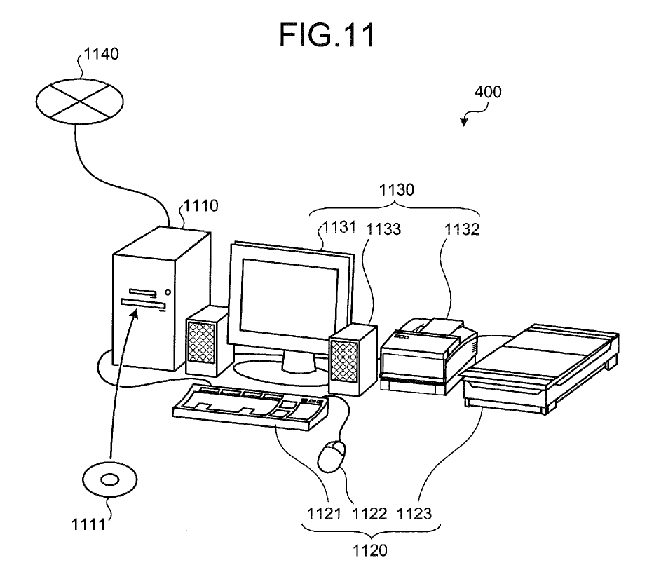

FIG. 11 is a schematic of hardware configuration of the spreadsheet generating apparatus 400.

As depicted in FIG. 11, the spreadsheet generating apparatus 400 depicted in FIG. 4 includes a computer 1110, an input device 1120, and an output device 1130, and may be connected with a network 1140, e.g., a local area network (LAN), a wide area network (WAN), or the Internet through a non-depicted router or a modem.

The computer 1110 has a central processing unit (CPU), a storage apparatus, and an interface. The CPU governs overall control of the spreadsheet generating apparatus 400. The storage apparatus is formed of, for example, read-only memory (ROM), a random access memory (RAM), a hard disk (HD), an optical disk 1111, or a flash memory. The RAM is used as a work area of the CPU.

Various programs are stored in the storage apparatus and loaded in response to a command from the CPU. The reading and the writing of data with respect to the HD and the optical disk 1111 are controlled by a disk drive. The optical disk 1111 and the flash memory are removable. The interface controls input from the input device 1120, output to the output device 1130, and transmission/reception with respect to the network 1140.

As the input device 1120, a keyboard 1121, a mouse 1122, and a scanner 1123 are adopted. The keyboard 1121 includes keys to input, for example, characters, numeric figures, and various kinds of instructions, and data is input through the keyboard 1121. The keyboard 1121 may be a touch panel. The mouse 1122 is used to move a cursor, select a range, move a window, or change window size. The scanner 1123 optically reads an image as image data, which is stored in the storage apparatus of the computer 1110. The scanner 1123 may have an OCR function.

As the output device 1130, a display 1131, a printer 1132, a speaker 1133, etc. are adopted. The display 1131 displays a cursor, an icon, or a tool box as well as data, such as text, an image, and function information. The printer 1132 prints image data or text data. The speaker 1133 outputs sound, e.g., a sound effect or a text-to-voice converted sound.

Functions of the spreadsheet generating apparatus 400 will be described. The spreadsheet generating apparatus 400 includes a cell-defining-information generating unit 430 and a spreadsheet output unit 440. First, the cell-defining-information generating unit 430 will be described. Cell defining information is definition information used to correlate item position on the form 100 and cell position in the spreadsheet.

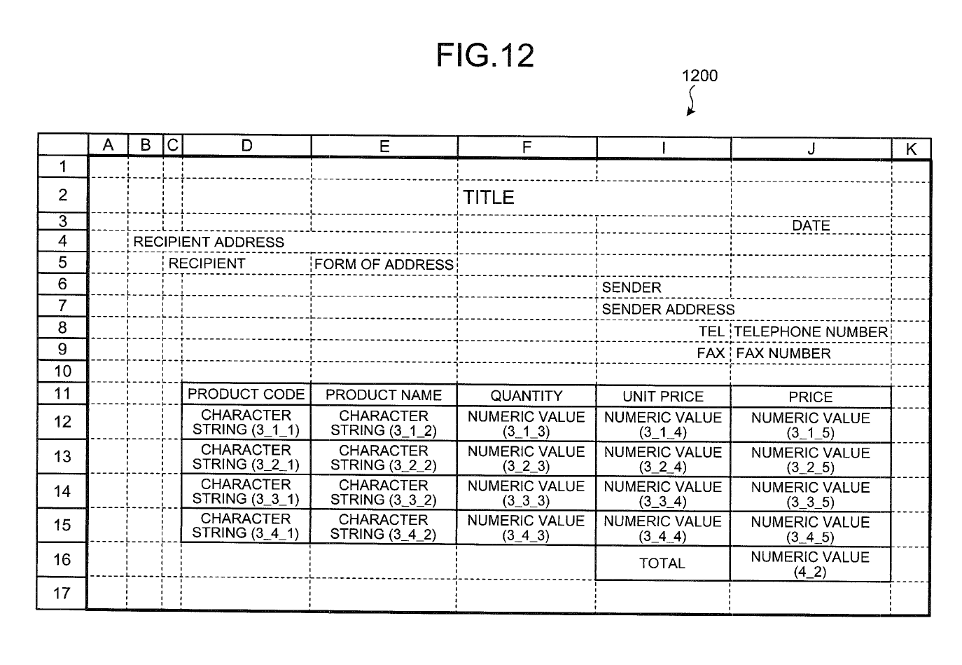

FIG. 12 is a schematic of cell defining information. The cell width, cell height, partition range, etc. of the cells A1 to K17 in the spreadsheet are defined as cell defining information 1200. For partition P1, the range is defined by row number, such as [1,10]. The cell defining information 1200 is automatically generated based on item position, etc. indicated by the format defining information 402.

The cell-defining-information generating unit 430 has a function of considering preservation of the layout of the form 100 and reusability of the data in the automatic generation of a cell, i.e., with output to the spreadsheet in mind, the cell-defining-information generating unit 430 is careful to not generate useless columns and rows as much as possible.

As a way to achieve this, division of the cell is controlled based on cell control information (basic column width, basic row height, rounding width, and rounding height) such that data in similar positions are located in the same columns and rows. Further, each of the values may be customized by the user and thus, optimal cell widths and cell heights are designed for each form 100.

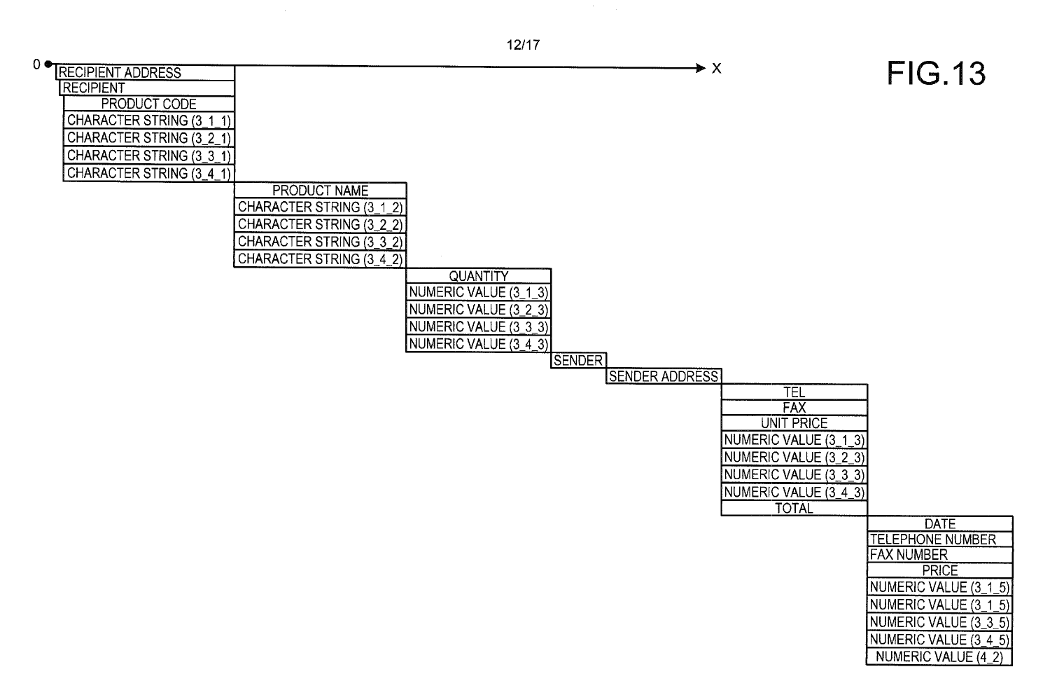

This processing uses the position information for each of the items, i.e., the position information included in the item information, which is included in the format defining information 402. With respect to column width, the X-coordinates indicated in the position information are sorted in ascending order. FIG. 13 is schematic of items sorted in ascending order of the X-coordinates.

From the X-coordinate of the head item after the sorting, checking is performed and the distance to the starting position of the next item is calculated. If the distance is below (basic column width x2), the calculated distance becomes the column width. On the other hand, if the distance is equal to or greater than (basic column width x2), the basic column width portion alone is moved and at the point when the basic column width portion becomes less than (basic column width x2), the column width is set thereat. Further, if the deviation of the item position is within the range of the rounding width, no adjustment is made and no useless column is generated. Thus, a cell column width is calculated for each item.

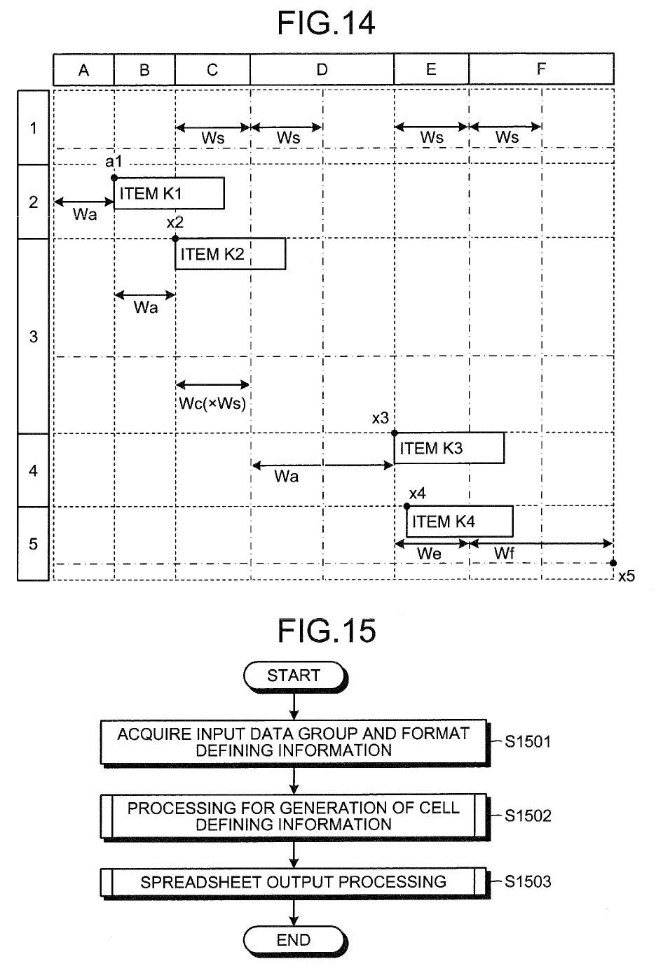

FIG. 14 is a schematic of column width adjustment. In FIG. 14, items K1 to K4 are sorted in ascending order. The X-coordinate values of the items K1 to K4 are x1 to x4, respectively. Further, the following is assumed, the basic cell width WS=960 dots, the basic cell height HS=240 dots, the rounding width ΔW=144 dots, and the rounding height ΔW=144 dots. The column width is adjusted as described hereinafter. Furthermore, [,] indicates a coordinate interval.

column A width: a=[0,x1−1]

column B width: Wb=[x1,x2−1]

column C width: Wc=[x2,x2+WS]

column D width: Wd=[x2+WS+1,x3−1]

column E width: We=[x3,x3+WS]

Where, at item K4, the distance between [x3,x4] is equal to or less than the rounding width ΔW and thus, the items K3 and K4 are in the same column (column E).

column F width: Wf=[x3+WS+1,x5]

Where, x5 is the X-coordinate of the last point of the form definition field 500.

Similarly, for the row height, the Y-coordinates indicated in the position information are sorted in ascending order. From the Y-coordinate of the head item after the sorting, checking is performed and the distance to the starting position of the next item is calculated. If the distance is below (basic row height x2), the calculated distance becomes the row height. On the other hand, if the distance is equal to or greater than (basic row height x2), the basic row height portion alone is moved and at the point when the basic row height portion becomes less than (basic row height x2), the row height is set thereat. Further, if the deviation of the item position is within the range of the rounding height, no adjustment is made and no useless column is generated. Thus, a cell row height is calculated for each item.

The spreadsheet output unit 440 has a function of separately outputting the data sheets 301 to 304 and the layout sheet 200. The sheet output unit 440, using the cell defining information 1200, converts the position information for the items into cells.

The cell position of a given item is determined based on the column width and the row height defined in the cell defining information 1200. Description will be given with respect to column width. The column widths of columns A to D defined in the cell defining information 1200 are 1440 dots, 1020 dots, 1760 dots, and 2400 dots, sequentially from column A. If the X-coordinate indicated by the position information of a given item is 5000, 5000 and the column width of column A (1440 dots) are compared.

If the value of the X-coordinate is greater, the column width (1020 dots) of the next column (column B) is added to the width of column A and the total is compared with the value of the X-coordinate. The total width of column A and column B is 2460 dots and thus, the column width (1760 dots) of the next column (column C) is added thereto and the total is compared with the value of the X-coordinate. The total width of column A to column C is 4220 dots and thus, the column width (2400 dots) of the next column (column D) is added thereto and the total is compared with the value of the X-coordinate. The total width of column A to column D is 6620 dots and thus, exceeds the value of the X-coordinate. Hence, the given item is placed in column D. By similar processing for the row height, cell positions corresponding to the items are determined in the layout sheet 200.

Further, the spreadsheet output unit 440 generates links linking the cell positions of the data in the data sheets 301 to 304 to the cell positions of the items in the layout sheet 200, and ultimately, generates and outputs the output file 450 that combines the layout sheet 200 and the data sheets 301 to 304.

FIG. 15 is a flowchart of spreadsheet generation processing according to the embodiment. As depicted in FIG. 15, the input data group 401 is acquired from the business application 410 and format defining information 402 is acquired from the form defining tool 420 (step S1501).

The cell-defining-information generating unit 430 executes processing for generation of the cell defining information (step S1502) and the spreadsheet output unit 440 executes spreadsheet output processing (step S1503).

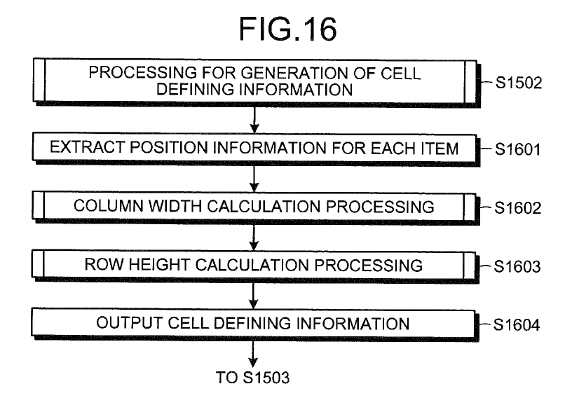

FIG. 16 is a flowchart of the processing for generation of the cell defining information. As depicted in FIG. 16, position information for each of the items is extracted from the format defining information 402 (step S1601).

Column width calculation processing is executed and the column width for the items is calculated (step S1602). Row height calculation processing is executed and the row height for the items is calculated (step S1603). Consequently, the column widths and the row heights of cells corresponding to the items are set and combined as the cell defining information 1200 and output (step S1604).

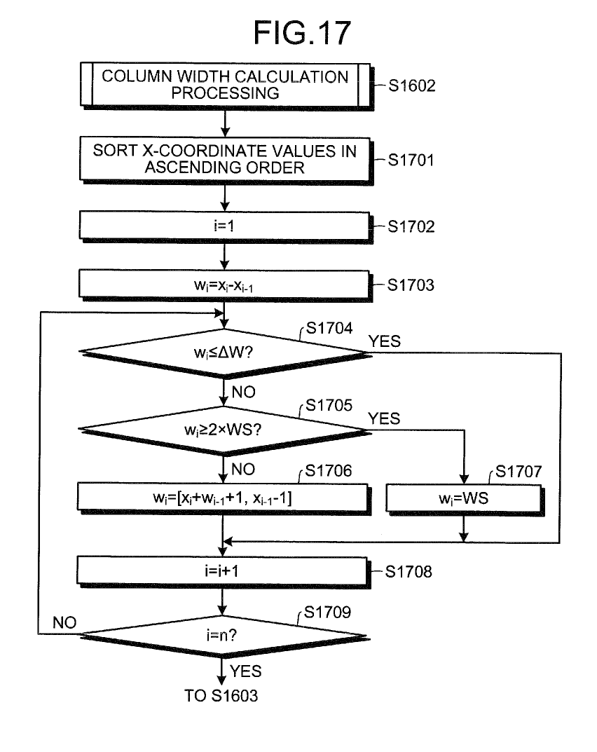

FIG. 17 is a flowchart of the column width calculation processing depicted in FIG. 16. As depicted in FIG. 17, the extracted values of the X-coordinates for the items are sorted in ascending order (step S1701). Next, i=1 is assumed (step S1702), where i indicates a sort position among the sorted X-coordinates.

The i-th column width wᵢ(=xᵢ−xᵢ₋₁) is calculated (step S1703). i=0 is indicative of the origin of the coordinate system of the form definition field 500. Subsequently, it is determined whether the i-th column width wᵢ is at most the rounding width ΔW (step S1704). If the i-th column width wᵢ is at most the rounding width ΔW (step S1704: YES), the processing proceeds to step S1708.

On the other hand, if the i-th column width wᵢ exceeds the rounding width ΔW (step S1704: NO), it is determined whether the i-th column width wᵢ is at least 2 times the basic column width WS (step S1705). If the i-th column width wᵢ is not at least 2 times the basic column width WS (step S1705: NO), the i-th column width wᵢ is calculated (step S1706), e.g., the i-th column width wᵢ=[xᵢ+wᵢ₋₁+1,xᵢ₋₁−1], and the processing proceeds to step S1708.

On the other hand, if the i-th column width wᵢ is at least 2 times the basic column width WS (step S1705: YES), the i-th column width wᵢ is regarded as the basic column width WS (step S1707), and the processing proceeds to step S1708. At step S1708, i is incremented (step S1708), and it is determined whether i=n (step S1709), where n is the total number of items. If i=n is determined to be not true (step S1709: NO), the processing returns to step S1704. On the other hand, if i=n is determined to be true (step S1709: YES), the processing proceeds to step S1603.

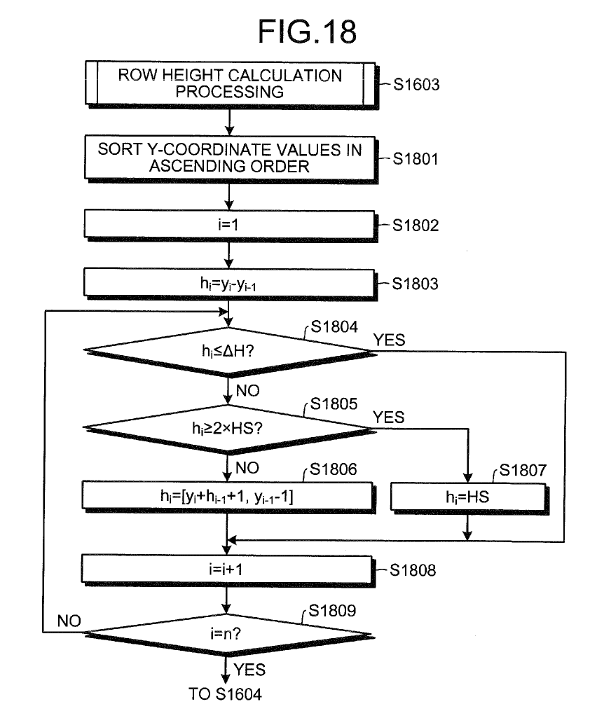

FIG. 18 is a flowchart of the column height calculation processing depicted in FIG. 16. As depicted in FIG. 18, the extracted values of the Y-coordinates for the items are sorted in ascending order (step S1801). Next, i=1 is assumed (step S1802), where i indicates a sort position among the sorted Y-coordinates.

The i-th column height hᵢ(=yᵢ-yᵢ₋₁) is calculated (step S1803). i=0 is indicative of the origin of the coordinate system of the form definition field 500. Subsequently, it is determined whether the i-th column height hᵢ is at most the rounding height ΔH (step S1804). If the i-th column height hᵢ is at most the rounding height ΔH (step S1804: YES), the processing proceeds to step S1808.

On the other hand, if the i-th column height hᵢ exceeds the rounding height ΔH (step S1804: NO), it is determined whether the i-th column height hᵢ is at least 2 times the basic column height HS (step S1805). If the i-th column height hᵢ is not at least 2 times the basic column height HS (step S1805: NO), the i-th column height hᵢ is calculated (step S1806), e.g., the i-th column height hᵢ=[yᵢ+hᵢ₋₁+1,yᵢ₋₁−1], and the processing proceeds to step S1808.

On the other hand, if the i-th column height hᵢ is at least 2 times the basic column height HS (step S1805: YES), the i-th column height hᵢ is regarded as the basic column height HS (step S1807), and the processing proceeds to step S1808. At step S1808, i is incremented (step S1808), and it is determined whether i=n (step S1809), where n is the total number of items. If i=n is determined to be not true (step S1809: NO), the processing returns to step S1804. On the other hand, if i=n is determined to be true (step S1809: YES), the processing proceeds to step S1604.

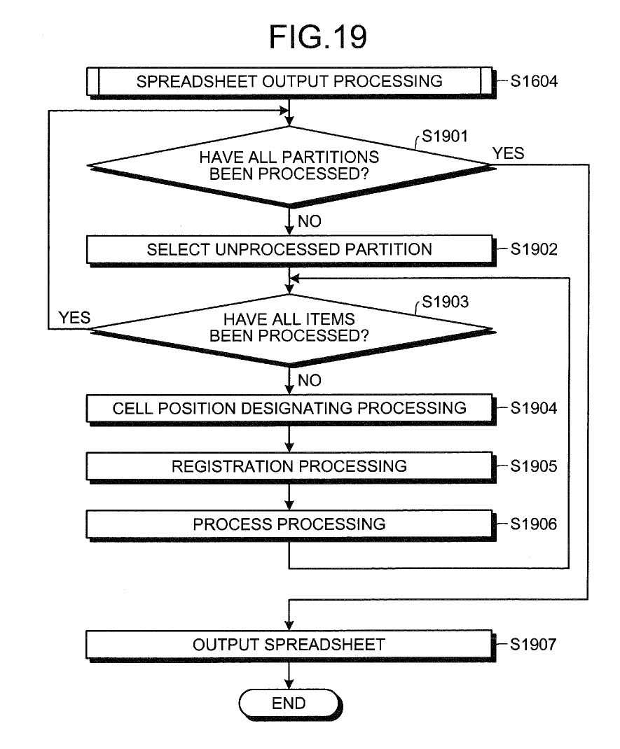

FIG. 19 is a flowchart of the spreadsheet output processing depicted in FIG. 15. As depicted in FIG. 19, it is determined whether all of the partitions have been processed (step S1901).

If all of the partitions have not been processed (step S1901: NO), an unprocessed partition is selected (step S1902). It is determined whether all of the items have been processed with regard to the selected partition (step S1903). If all of the items have not been processed (step S1903: NO), cell position designating processing is executed (step S1904).

Cell position designating processing includes sequentially calculating from column A, column widths of the cell defining information 1200 and determining a column that is at least the value of the X-coordinate of a given item to be the column for the given item. Similarly, for the rows, row heights of the cell defining information 1200 are sequentially calculated from row 1 and a row that is at least the value of the Y-coordinate of the given item is determined to be the row of the given item. Thus, a cell is designated by a column equal to or greater than the value of the X-coordinate for an item and a row equal to or greater than the value of the Y-coordinate of the item.

Subsequently, registration processing is executed (step S1905). Registration processing includes identifying the item name of a given item from a data string using the format defining information 402 as a hint, and correlating the given item for which the item name has been identified with a cell at the cell position of the given item. Hence, for example, under an item name for an item such as “TITLE”, “INVOICE” is written and is located in cell F2 as depicted in FIG. 2.

Subsequently, process processing is executed (step S1906). Process processing includes referencing the format defining information 402 to determine the font of the item name written to the cell, apply hatching to the cell, etc. Further, in the case of a numeric value, by referencing the editing format, display in a format compatible with the spreadsheet format is enabled. Subsequently, the processing returns to step S1903.

At step S1903, if all of the items have been processed (step S:1903: YES), the processing returns to step S1901. At step S1901, if all of the partitions have been processed (step S1901: YES), the processing proceeds to step S1907.

At step S1907, the layout sheet 200 is generated as a spreadsheet (refer to FIG. 2). Further, the input data group 401 is generated as the data sheets 301 to 304 (refer to FIG. 3). At this time, cells describing the data (item names) in the data sheets 301 to 304 and the layout sheet 200 describing the same item names are linked to correlate the cells describing the item names in the layout sheet 200 and the data (i.e., the item names) in the input data group 401.

A group of spreadsheets that combines the layout sheet 200 and the data sheets 301 to 304 is output (step S1907). The output format is, for example, compressed and saved under an XML format, displayed on a display, printed out, transmitted to an external computer, etc.

As described, the embodiment enables data processing to be executed separately in terms of data (item names) and formatting (automatic generation). That is, since data conversion is automated, data (item names) and formatting are handled separately, unlike conventional printout processing involving edit processing based on format definitions (formatting) and data, and printout.

The data (item names) are categorized as character strings, numeric values, time, etc., and conversion to values corresponding to data format is implemented. With regard to formatting, formatted character strings are generated to be displayed by the format specified by the format definition (formatting) and are converted to a spreadsheet.

In this way, the embodiment supports cases when the data (item names) are to be subject to secondary utilization or displayed as is in a printed form. The data (item names) and formatting are handled separately and thus, data conversion for secondary utilization becomes unnecessary.

The present embodiment enables automatic generation of cell widths, cell heights, and cell linking. That is, since a layout similar to the printed data is preserved, optimal cell widths and cell heights are automatically generated from item positions in the format definition (layout) and the area occupied by the items and thus, conversion to spreadsheets having few useless columns and rows is performed.

With respect to the data (item names), since there is no concept of cells, defining cell information similar to the printed data becomes extremely difficult. Although defining cells by minute cell units enables positions to be matched with print positions, if the data (item names) are to be reutilized, numerous useless columns of data are included, arising in reutilization problems.

Thus, by preserving the print image while automatically generating cell information for which cell width and cell height have been adjusted so that useless columns are not generated from item positions and areas occupied by the items, it becomes possible to automatically generate spreadsheets affording high secondary utilization of the data (item names). Further, since existing printing systems may be utilized, the cost and time for application development are reduced.

Moreover, the present embodiment enables the realization of document management that separately handles the data sheets 301 to 304 and the layout sheet 200, i.e., secondary utilization of the data is improved and thus, the data sheets 301 to 304 and the layout sheet 200 are integrated. For example, the data (item names) are output to the data sheets 301 to 304, in a format corresponding to CSV data and the print image is generated and managed as the layout sheet 200.

From the layout sheet 200, the data sheets 301 to 304 are referenced (linked) and thereby, the data sheets 301 to 304 are converted and the print image is also converted. Accordingly, the data is consolidated and managed, and even if plural layout sheets 200 are generated, by correcting the data sheets 301 to 304 alone, the other layout sheets 200 need not be corrected. Thus, management is simplified and spreadsheets affording high secondary utilization, for calculation and layout, are generated.

The spreadsheet generating method explained in the present embodiment may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium storing therein a spreadsheet generating program that causes a computer to execute:
acquiring information related to layout positions of items in a form;
column-sorting the items in ascending order, according to column-related coordinate values of the items;
determining a column width for each of the items, based on a distance from the item to the previous item in the column-sorted items;
row-sorting the items in ascending order, according to row-related coordinate values of the items;
determining a row height for each of the items, based on a distance from the item to the previous item in the row-sorted items;
designating, for each of the items and from among cells having the determined column widths and the determined row heights, a cell corresponding to a layout position indicated in the acquired information related to layout positions; and
outputting a spreadsheet related to layout of the form by provision of the items to the designated cells, respectively.

2. The computer-readable recording medium according to claim 1 and storing therein the spreadsheet generating program that causes a computer to further execute:
assessing whether the distance is at least a given column width that is greater than a reference column width, wherein
the determining the column widths includes determining the column widths based on a result obtained at the assessing.

3. The computer-readable recording medium according to claim 2, wherein
the determining the column widths includes determining a column width to be the reference column width when at the assessing, the distance is assessed to be at least the given column width.

4. The computer-readable recording medium according to claim 2, wherein
the determining the column widths includes determining a column width to be the distance when at the assessing, the distance is assessed to be less than the given column width.

5. The computer-readable recording medium according to claim 1 and storing therein the spreadsheet generating program that causes a computer to further execute:
judging whether the distance is at most a rounding width that is less than the reference column width, wherein
the determining the column widths includes determining the column widths based on a result obtained at the judging.

6. The computer-readable recording medium according to claim 5, wherein
the determining the column widths includes not determining a column width when at the judging, the distance is judged to be at most the rounding width.

7. The computer-readable recording medium according to claim 5, wherein
the determining the column widths includes determining a column width to be the distance when at the judging, the distance is judged to exceed the rounding width.

8. The computer-readable recording medium according to claim 1 and storing therein the spreadsheet generating program that causes a computer to further execute:
assessing whether the distance is at least a given row height that is greater than a reference row height, wherein
the determining the row heights includes determining the row heights based on a result obtained at the assessing.

9. The computer-readable recording medium according to claim 8, wherein
the determining the row heights includes determining a row height to be the reference row height when at the assessing, the distance is assessed to be at least the given row height.

10. The computer-readable recording medium according to claim 8, wherein
the determining the row heights includes determining a row height to be the distance when at the assessing, the distance is assessed to be less than the given row height.

11. The computer-readable recording medium according to claim 1 and storing therein the spreadsheet generating program that causes a computer to further execute:
judging whether the distance is at most a rounding height that is less than the reference row height, wherein
the determining the row heights includes determining the row heights based on a result obtained at the judging.

12. The computer-readable recording medium according to claim 11, wherein
the determining the row heights includes not determining a row height when at the judging, the distance is judged to be at most the rounding height.

13. The computer-readable recording medium according to claim 11, wherein
the determining the row heights includes determining a row height to be the distance when at the judging, the distance is judged to exceed the rounding height.

14. The computer-readable recording medium according to claim 1, wherein
the acquiring includes acquiring data strings related to corresponding names of the items, and
the outputting includes outputting the spreadsheet related to the layout of the form by a provision of the items and the corresponding names of the items to the designated cells.

15. The computer-readable recording medium according to claim 14, wherein
the acquiring includes acquiring format defining information defining a format related to the items, and
the outputting includes outputting the spreadsheet related to the layout of the form by a provision of the items, the corresponding names of the items, and the format defining information to the designated cells.

16. The computer-readable recording medium according to claim 14, wherein
the outputting includes outputting an output file comprising a spreadsheet related to the layout of the form and a spreadsheet related to the corresponding names of the items.

17. The computer-readable recording medium according to claim 16, wherein
the output file, concerning common items, correlates cells in the spreadsheet related to the layout of the form with cells in the spreadsheet related to the corresponding names of the items.

18. A spreadsheet generating apparatus comprising:
an acquiring unit that acquires information related to layout positions of items in a form;
a first sorting unit that sorts the items in ascending order, according to column-related coordinate values of the items;
a first determining unit that determines a column width for each of the items, based on a distance from the item to the previous item in the items sorted by the first sorting unit;
a second sorting unit that sorts the items in ascending order, according to row-related coordinate values of the items;
a second determining unit that determines a row height for each of the items, based on a distance from the item to the previous item in the items sorted by the second sorting unit;
a designating unit that, for each of the items and from among cells having the column widths determined by the first determining unit and the row heights determined by the second determining unit, designates a cell corresponding to a layout position indicated in the acquired information related to layout positions; and
an output unit that outputs a spreadsheet related to layout of the form by provision of the items to the designated cells, respectively.

19. A spreadsheet generating method comprising:
acquiring information related to layout positions of items in a form;
column-sorting the items in ascending order, according to column-related coordinate values of the items;
determining a column width for each of the items, based on a distance from the item to the previous item in the column-sorted items;
row-sorting the items in ascending order, according to row-related coordinate values of the items;
determining a row height for each of the items, based on a distance from the item to the previous item in the row-sorted items;
designating, for each of the items and from among cells having the determined column widths and the determined row heights, a cell corresponding to a layout position indicated in the acquired information related to layout positions; and
outputting a spreadsheet related to layout of the form by provision of the items to the designated cells, respectively.
